(19) United States
(12) Patent Application Publication
(10) Pub. No.: US 2001/0052927 A1
(43) Pub. Date: Dec. 20, 2001

(54) Light source unit for optical scanning device

(75) Inventors: Yoshiyuki Takase, Saitama (JP); Shuzo Kimura, Saitama (JP)

Correspondence Address: YOUNG & THOMPSON, 745 SOUTH 23RD STREET 2ND FLOOR, ARLINGTON, VA, 22202

(73) Assignee: Fuji Photo Optical Co., Ltd.

(21) Appl. No.: 09/820,855

(22) Filed: Mar. 30, 2001

(30) Foreign Application Priority Data
Mar. 31, 2000 (JP) 2000-096866

(51) Int. Cl. B41J 27/00

(52) U.S. Cl. 347/257

(57) ABSTRACT

A light source unit having optical elements which include a laser source, a collimator lens, a cylindrical lens and an optical path adjusting optical parallel mounted in fixed positions on a metal mount is adjusted to provide given optical characteristics and secured to a plastic housing of an optical scanning device. After optical scanning device is installed to an image forming machine so as to direct a scanning beam from the laser source toward an image carrier which is scanned by the scanning beam.

### BACKGROUND OF THE INVENTION

1. Field of the Invention

The present invention relates to a light source unit including at least a light source producing, for example, a laser beam for an optical scanning device, and more particularly, to a light source unit comprising a light source holding mechanism for an optical scanning device which is suitably used in such an image forming machine that scans an image carrier such as a photoelectric drum by a light beam emanating from the light source so as to form an electrostatic latent image on the image carrier, develops the electrostatic latent image as a toner image and then transfers the toner image to an image recording medium such as a paper.

2. Description of the Related Art

There have been well known a variety of image forming machines, such as copy machines, printers and facsimile machines, for forming a subject image on a recording paper. Many of such image forming machines use laser beams as scanning beams. Such an image forming machine is equipped with an optical scanning device comprising a semi-conductor laser source emitting a laser beam bearing image information of a subject, a rotary polygon mirror operative to reflect and deflect the laser beam and an ƒθ lens system which performs regulation of the laser beam after deflection to form an image of the subject without distortion, and reflection optical means for directing the laser beam to an image carrier moving in a specified direction such as a rotary photosensitive drum so as thereby to form a electrostatic latent image scanning a surface of the photosensitive drum with the laser beam. The electrostatic latent image on the photosensitive drum is developed as a toner image and then transferred to a printing medium such as a printing paper.

One type of color image forming machine employs an optical scanning device which comprises single reflection and deflection means and an optical system commonly to a plurality of laser beams. Another type of color image forming machine, which is called a tandem type, employs an optical scanning device which comprises a plurality of reflection and deflection means and an optical system one for each scanning beam. The former type is advantageous to compactness and simple controllability of the image forming machines. For example, such a color image forming machine for recording a color image is typically equipped with an optical scanning device that uses four laser beams, namely a yellow (Y) image information bearing laser beam, a magenta (M) image information bearing laser beam, a cyan (C) image information bearing laser beam and a black (BL) image information bearing laser beam with which a photosensitive image carrier is scanned to form an electrostatic latent image thereon. On the other hand, another type of image forming machine is provided with an optical scanning device which uses two laser beams in an attempt to record an image quickly. The two laser beams scan a photosensitive image carrier simultaneously but at different positions, respectively.

These image forming machines employing a plurality of canning beams have the necessity that laser sources generating the scanning beams have to be kept precisely in position relative to one another. That is, if there occurs even a slight positional shift of the light source, deviations in scanning position of the scanning beams are magnified on the image carrier by the scanning optical system including deflection means and an ƒθ lens system, resulting in an unclear and/or distorted image that is formed on a recording paper. The deviation in scanning position of the scanning beam possibly occurs due to vibrations of the scanning optical system that are caused by a drive motor of the deflection means such as a deflection polygon mirror. In order to avoid such a vibration, there have been proposed in, for example, Japanese Unexamined Patent Publications Nos. 9-159955 and 9-187986 various optical scanning devices for electrophotographic machines in which vibration proofing means is installed between the drive motor and the deflection polygon mirror.

Image forming machines are accompanied by an optical scanning devices comprising a light source, deflection means, an ƒθ lens system and a reflective optical system. The optical scanning device is mounted on a base panel and is installed into a housing of the image forming machine as one whole together with an image carrier which is scanned by the scanning beams, a developing device, a fixing device, a processing control device, etc. Some base panels on which the optical scanning device is mounted are made of plastic sheets. However, Such a plastic base panel possibly causes a thermal deformation in shape due to a change in ambient temperature. The deformation of the plastic base panel causes a change in relative position of the light sources with the result of deviations in scanning position, and hence a distortion of an image.

In the case where the base panel is made of a steel sheet which is resistant to a change in ambient temperature and is hard to cause deformation, the optical scanning device raises its own costs, and hence the cost of the image forming machine.

### SUMMARY OF THE INVENTION

It is therefore an object of the present invention to provide a light source holding mechanism for an optical scanning device installed to an image forming machine, which prevents light sources from getting out of adjusted relative position due to a change in ambient temperature and keeps the light sources in adjusted position.

It is another object of the present invention to provide a light source holding mechanism for an optical scanning device installed to an image forming machine, which prevents the optical scanning device from causing a distortion of image formed by the optical scanning device so as to provide a clear and sharp image.

The foregoing objects of the present invention are accomplished by a light source unit comprising at leas one light source which is suitably used together )with an optical scanning device having a housing and an scanning optical system including deflection means arranged in the housing for deflecting a scanning beam emanating from the light source and impinging thereon so as to direct the scanning beam toward an image carrier such as a photosensitive drum which is scanned by the scanning beam. The light source unit comprises a light source mount configured so as to fixedly hold the light source, which is made of a member having a coefficient of thermal liner expansion within a specified permissible extent and positioning means for positioning the light source mount in a specified location relative to the housing and detachably fixing the light source mount to the housing.

The optical scanning device is completed by installing the light source unit to the housing of the optical scanning device positioning and fixing the light source unit in a specified location relative to the housing by the positioning means. The optical scanning device is easily installed to an image forming machine. The light source mount may be made of any members hardly deformable due to a change in ambient temperature such as aluminum, aluminum alloys, sintered metals and plastics reinforced by, for example, reinforcing additives. As the light source mount causes only a small thermal deformation, the optical scanning device is prevented from encountering a positional shift of the light source relative to the scanning optical system due to a change in ambient temperature, so as to keep given optical performance thereof If there occurs a positional shift of the light source relative to the scanning optical system, the positional shift is reflected as an increased shift in scanning position of the scanning beam on the image carrier through the scanning optical system. This possibly makes an image formed on the image carrier significantly blurred. However, even though there occurs a positional shift of one or more optical elements of the scanning optical system, the optical scanning device keeps the given optical performance as long as there occurs no positional shift of the light source. Therefore, the optical scanning device can remain unchanged in optical performance by keeping the light source in the given position relative to the scarring optical system.

The light source mount may be any members as long as the member causes a deformation within a specified permissible extent due to at least either one of a change in ambient temperature and external force. The light source mount is made of a member which causes only a permissible deformation due to a change in ambient temperature and/or external force. When the housing of the optical scanning device causes a deformation, the light source mount possibly receives a stress generating in the housing due to the deformation as external force. In such a case, a deformation of the light source mount due to the external force is small, so that the light source mount protects the light source from shifting from the specified position. This keeps the optical scanning device working with the given optical performance. The external force is exerted on the light source mount in various forms such as stress in the housing of the optical scanning device which is produced by, for example, a thermal deformation of the housing or a deformation due to a change with age of the housing or excessive fastening force with which set screws or the like are fastened to secure the housing of the optical scanning device to a frame of an image forming machine.

The light source mount may be made of any members that cause only a small thermal deformation or a deformation due to external force. Such a member may be selected from a group of aluminum, aluminum alloys, sintered metals and plastics reinforced by, for example, reinforcing additives.

In the case where the optical scanning device is incorporated in a color image forming machine which employs a plurality of scanning beams emanating independent light sources, respectively, the light source mount holds all of a plurality of light sources. Since the light source mount does not cause a shift in relative position of the light source, the optical scanning device causes no shift in scanning position of scanning beams on an image carrier that is scanned by the scanning beams. This prevents the color image forming machine from forming a distorted and/or unclear color image.

The light source unit may further comprise a collimator lens and a cylindrical lens in order to collimate and focus the scanning beam on the image carrier. The optical scanning device comprises mainly the light source unit preferably including scanning beam regulation means for regulating a scanning beam emanating from the light source suitably for scanning and the scanning optical system operative to deflect and direct the regulated scanning beam to an image carrier such as a photosensitive drum of an image forming machine so as to scan the image carrier. If there occurs a positional shift of the light source relative to the scanning optical system, the scanning position of the scanning beam shifts from an intended position on the image carrier with the result of causing distortion and/or unclearness of an image. Therefore, the collimator lens and cylindrical lens as essential optical elements forming part of the light source unit are preferred to be mounted on the light source mount so as to be prevented from shifting in relative position thereof

The light source unit may further comprise scanning beam path adjusting means, in addition to the collimator lens and cylindrical lens, for shifting an optical path of a scanning beam coming out of the scanning beam path adjusting means from and parallel with an original optical path of the scanning beam incident upon the optical parallel (which is hereafter referred to as an original optical path of the scanning beam). In the case where a plurality of light sources are employed, the scanning beam path adjusting means is provided in order to adjust a distance of at least one scanning beam from the remaining scanning beams. The scanning beam path adjusting means may comprise an optical parallel interesting the scanning beam at an angle greater or less than 90°.

### BRIEF DESCRIPTION OF THE DRAWINGS

The above and other objects and features of the present invention will be clearly understood from the following description with respect to the preferred embodiment thereof when considered in conjunction with the accompanying drawings, wherein the same reference numerals have been used to denote the same or similar parts or elements, and in which:

FIG. 1 is a schematic plan view of an optical scanning device having two light sources held by a light source holding mechanism in accordance with a preferred embodiment of the present invention;

FIG. 2 is a schematic perspective view of the optical scanning device shown in FIG. 1;

FIG. 3 is an exploded perspective view of the light source holding mechanism; and

FIG. 4 is a perspective view, similar to FIG. 1, showing details of the optical scanning device having two light sources held by the light source holding mechanism shown in FIG. 3.

### DETAILED DESCRIPTION OF THE PREFERRED EMBODIMENTS

Parts which are not direct importance to the invention and parts which are purely of conventional construction will not be described in detail. For example, details of the scanning optical system, the polygon deflection mirror, the ƒθ lens system, etc. which are necessary to the optical scanning device will not be set out in detail since their construction and operation can be easily arrived by those skilled in the art.

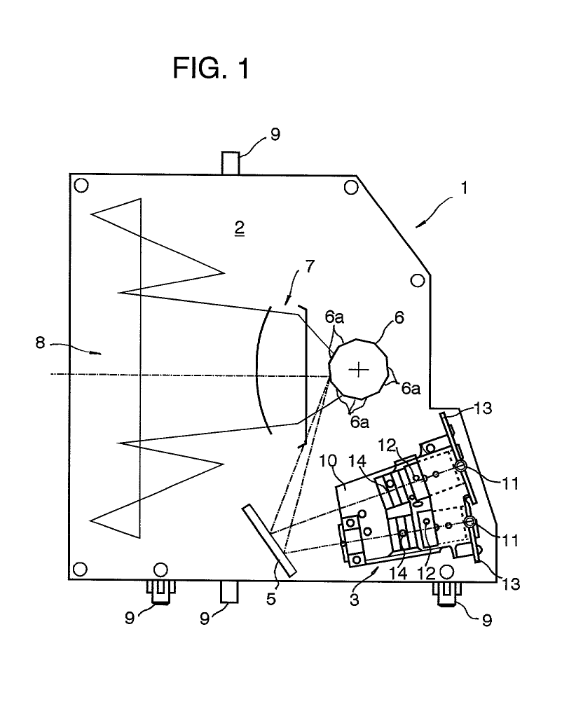

Referring to the drawings in detail, FIGS. 1 to 4 showing an optical scanning device 1 equipped with a light source holding mechanism in accordance with a preferred embodiment of the present invention, the optical scanning device 1 includes a generally box-shaped plastic housing 2 comprising a base wall 2a and a side wall 2b. A light source unit 3 fixedly mounted on a light source mount 10 is fixedly mounted to one corner section of the plastic housing 2. The light source unit 3 includes a pair of laser sources 11 such as laser sources that emit laser beams as scanning beams, respectively.

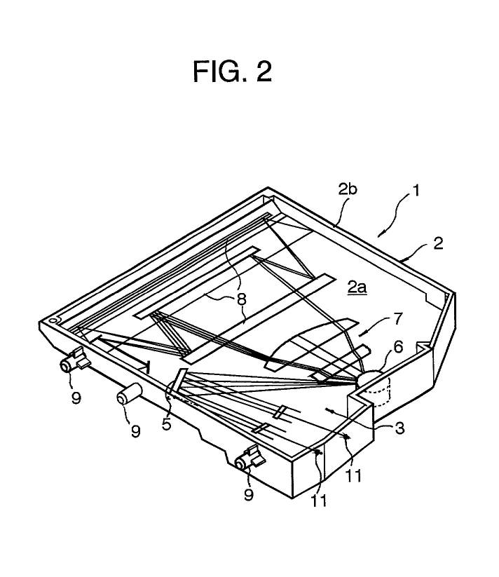

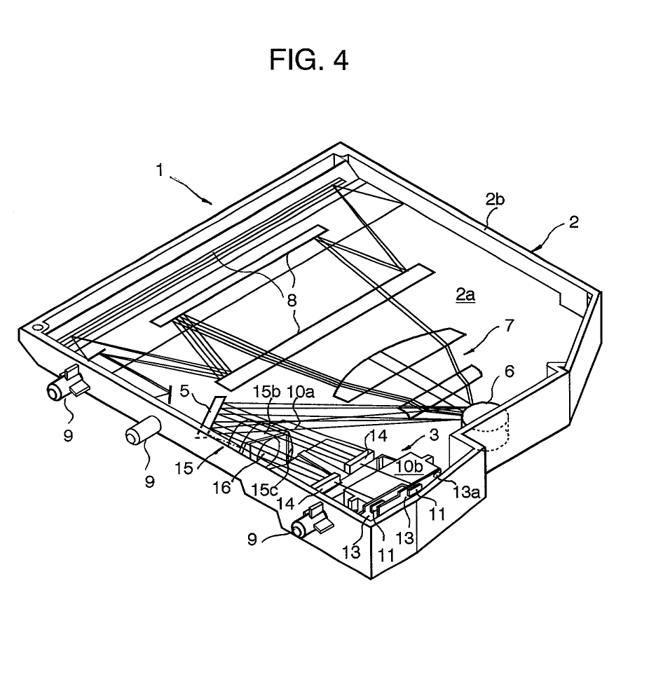

As shown in detail in FIGS. 2 and 4, a scanning optical system is mounted on the base wall 2a of the housing 2. This scanning optical system includes a stationary reflection mirror 5, a polygon mirror 6 as reflective deflection means and a stationary arrangement of reflection mirrors 8. The reflection mirror 5 is positioned so as to reflect and direct the scanning beams emanating from the laser sources 11 to the deflection polygon mirror 6. The deflection polygon mirror 6 has an equilateral cross section and is formed with reflective surface at its side facets 6a. The deflection polygon mirror 6. is mounted for rotation on the base wall 2a, so as to reflect and deflect the scanning beams impinging on the reflective facets 6a in order. Specifically, as the deflection polygon mirror 6 rotates, a reflective facet 6a changes an angle relative to the reflection mirror 5, as a result of which a reflection angle of the scanning beam incident upon the reflective facet 6a continuously varies. The scanning beam reflected and deflected by the deflection polygon mirror 6 travels to an ƒθ lens system 7, and regulated by the ƒθ lens system 7 for modification suitable for scanning. Thereafter, the scanning beam is reflected by the reflection mirror arrangement 8 operative to reflect the scanning beam back and forth and is finally directed toward an image carrier so as to scan the image carrier.

The housing 2 is provided with a plurality of positioning bosses 9 extending laterally outward from the side wall 2b. When installing the optical scanning device 1 to an image forming machine (not shown), the bosses 9 of the positioning housing 2 are fitted into circular or semi-circular positioning recesses formed in a housing frame of the image forming machine so as thereby to put the optical scanning device 1 in a predetermined relative position with respect to an image carrier such as a photosensitive drum of the image forming machine which is scanned by the scanning beams. While the deflection polygon mirror 6 rotates at a predetermined fixed speed, the scanning beams is reflected and deflected continuously by the reflective facets 6a so as to scan the image carrier.

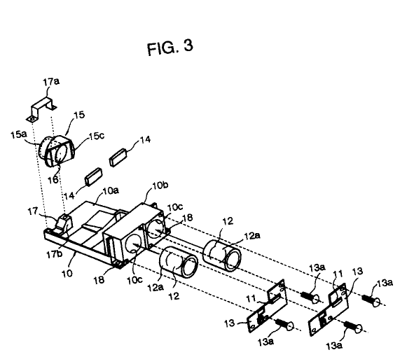

Referring to FIG. 3, the light source mount 10 on which the light source unit 3 is fixedly mounted is made of a member such as aluminium, aluminium alloys, sintered metals and other metals which are hardly deformable due to a change in ambient temperature and have small coefficients of linear expansion. The light source mount 10 is preferred to be made of a member which is hardly deformable due to certain external force such as stress caused by deformation of the housing 2 and exerted on the light source mount 10. In this instance, the light source unit 3 comprises the pair of laser sources 11 and a pair of optical systems that regulate the laser beams emanating from the laser sources 11 to specified optical characteristics, respectively. Specifically, the light source mount 10 comprises a base wall 10a and a lens mount 10b at rear end of the base all 10a which are formed as one piece. The light source unit 3 comprises, in addition to the laser sources 11, a pair of collimator lenses 12 and a pair of cylindrical lenses 14. Specifically, the lens mount 10b is formed with lens bores 10c in which the collimator lenses 12 received in lens barrels 12a are fixedly held The cylindrical lenses 14 are mounted on the base wall 10a on a side of the lens mount 10b remote from the laser sources 11 such that the cylindrical lenses 14 are in coaxial alignment with the collimator lenses 12, respectively. Laser source boards 13 to which the laser sources 11 such as laser diodes are fixedly mounted are secured to the lens mount 10b by set screws 13a such that the laser source 11 are in coaxial alignment with the collimator lenses 12, respectively.

In front of one of the cylindrical lenses 14 there is scanning beam path adjusting means 15 mounted on a V-shaped support mount 17 forming part of the base wall 10a of the light source mount 10. The scanning beam path adjusting means 15 comprises a front cylindrical block portion 15a formed with a front cylindrical through bore and a rear cylindrical block portion 15b formed with a rear cylindrical through bore continuous from the front cylindrical through bore of the cylindrical block portion 15a. The rear cylindrical block portion 15b has an external diameter greater than the front cylindrical block portion 15a and is formed as an integral part of the front cylindrical block portion. The cylindrical block portion 15a is supported for rotation on the V-shaped support mount 17 by a generally U-shaped leaf spring 17a. The cylindrical support block 15b at its rear end is formed with a support slope 15c intersecting an optical axis of the collimator lens 12 at a certain angle less or greater than 90°. An optical parallel 16 such as a glass plate is supported on the support slope 15c, so that the surface of the optical parallel 16 intersects the optical axis of the collimator lens 12 at the certain angle. The V-shaped support mount 17 and the cylindrical block portion 15a. of the scanning beam path adjusting means 15 are configured such that the axis of rotation of the cylindrical block portion 15a. of the scanning beam path adjusting means 15 is in alignment with the optical axis of the collimator lens 12.

According to the scanning beam path adjusting means 15, the scanning beam incident upon the optical parallel 16 is displaced close to or away from the axis of rotation of the scanning beam path adjusting means 15, and hence the axis of the collimator lens 12. The scanning beams incident upon and coming out of the optical parallel 16, respectively, are parallel with each other. The distance between the original optical path and the optical path of the scanning beam coming out of the optical parallel 16 in a direction perpendicular to the optical paths of the scanning beam depends upon an incident angle of the scanning beam upon the optical parallel 16. The optical path of the scanning beam coming out of the optical parallel 16 turns in a circle with a radius equal to the distance about the original optical path of the scanning beam as the scanning beam path adjusting means 15 turns about the axis of rotation thereof Accordingly, the lateral distance between the scanning beams after the light source mount 10 can be adjusted as required by tuning the scanning beam path adjusting means 15.

The light source mount 10 is formed with positioning holes 18 at opposite comers of the lens mount 10b thereof. On the other hand, the housing 2 is provided with positioning bosses (not shown) fitable into the positioning holes 18. Therefore, after installing the light source mount 10 to the housing 2 by bringing the positioning bosses into engagement with the positioning holes 18, the light source mount 10 is fixedly secured to the housing 2 in a predetermined relative position, so as thereby to direct the scanning beams emanating from the laser sources 11 to the reflection mirror 5.

In the operation of the light source holding mechanism structured as described above, after installing optical elements, namely the laser source boards 13 with the laser source 11 mounted thereon, the collimator lenses 12, the cylindrical lenses 14 and the scanning beam path adjusting means 15, to the light source mount 10, optical adjustment of the scanning beam path adjusting means 15 is made so that the scanning beams are parallel with each other and directed toward the reflection mirror 5 keeping a desired lateral distance between the scanning beams after one of the scanning beams has passed through the scanning beam path adjusting means 15. Specifically, the laser beams emanating the laser sources 11, respectively, are collimated by the collimator lenses 12, respectively and focused on a plane at a distance, equivalent to a distance between, for example, the deflection polygon mirror 6 and an image carrier of the image forming machine in which the optical scanning device 1 is installed, by the cylindrical lens 14. Subsequently, the scanning beam path adjusting means 15 is turned so as to displace the one of the scanning beams close to or away from another scanning beam, providing an appropriate lateral distance between the scanning beams. When the optical adjustment is completed, the scanning beam path adjusting means 15 is cemented, or otherwise secured, to the V-shaped support mount 17, completing adjustment of the light source unit 3.

Thereafter, the light source mount 10 is positioned in a predetermined relative position on the box-shaped plastic housing 2 of the optical searching device 1 by engaging the positioning bosses with the positioning holes 18 of the light source mount 10 and secured to the box-shaped plastic housing 2 of the optical scanning device 1 in a well known manner. As a result the scanning beams emanating the laser beams 11 are directed so as to impinge upon the reflection mirror 5. The optical scanning device 1 is attached to the image forming machine in a predetermined relative position by engaging the positioning bosses 9 with the positioning recesses of the housing frame of the image forming machine. Finally, optical adjustment of the image forming machine is made by adjusting an optical paths to the image carrier that is provided by the reflection mirror 5, the deflection polygon mirror 6, the ƒθ lens system 7 and the reflection mirror arrangement 8, thereby completing the image forming machine.

Even in the event where the image forming machine thus structured is over-heated due to long time operation, the light source unit 3 is prevented from causing a change in relative position of the laser sources 11 because it is mounted to the light source mount 10 which is free from thermal deformation. This secures the scanning beams emanating from the laser sources 11 from a change in relative position. Therefore, the scanning beams are kept unchanged in scanning position on the image carrier of the image forming machine, so that the image forming machine forms an image to be transferred onto a recording medium such as a paper without producing distortion and unclearness of the image. Furthermore, the optical elements forming parts of the light source unit 3 including the collimator lenses 12, the cylindrical lenses 14 and the scanning beam path adjusting means 15 are kept unchanged in position relative to the laser sources 11, so as to maintain given optical characteristics of the optical scanning device 1.

Although the light source mount 10 has been described as being made of metal by way of example, any materials may be employed to form the light source mount 10 as long as they are free from thermal deformation due to a change in ambient temperature. For example, the light source mount 10 may be made of a plastic reinforced by a reinforcing material operative to control thermal deformation due to a change in ambient temperature. In this connection, plastics have coefficients of linear expansion between 8.0×10⁻⁵ and 10.0×10⁻⁵, and a steel has a coefficients of linear expansion of 11.7×10⁻⁶. As apparent, the steel has a significantly smaller coefficient of liner expansion than the plastics and, inconsequence, is more hardly deformable due to a change in ambient temperature than the plastics. Aluminium and aluminium bronze have coefficients of liner expansion of 23.1×10⁻⁶ and 15.9×10⁻⁶, respectively, which are smaller than that of the plastics. Accordingly, these aluminium and aluminium bronze may be employed utilized to from the light source mount 10. Although polycarbonate glass containing 30% of glass has a coefficient of liner expansion of 25.0×10⁻⁶ to 30.0×10⁻⁶ which is two to three times as great as that of the steel, nevertheless, the polycarbonate glass may be employed to form the light source mount 10 as long as the coefficient of liner expansion is within a permissible extent.

Although the light source holding mechanism has been described as the light source unit 3 for an optical scanning device using two scanning beams, it can be employed as a light source unit for an optical scanning device using three or four scanning beams which is incorporated in color image forming machines.

According to the light source unit for an optical scanning device of the present invention in which optical elements of the light source unit are mounted on a light source mount made of a member causing only a small thermal deformation, even in the event where an image forming machine equipped with the optical scanning device is over-heated due to long time operation, the light source mount prevents a light source and optical elements mounted thereon from shifting relative positions of the light source and the optical element, so as to secure given optical performance of the optical scanning device. As a result, the image forming machine forms an image on a recording medium without producing unclearness of the image.

The light source mount made of a member hardly deformable due to external force is protected from deformation even when it receives stress producing in a housing of the optical scanning device due to a deformation of the housing. This is also contributory to forming an image on a recording medium without producing unclearness of the image.

Even in the case where the optical scanning device is incorporated in a color image forming machine which employs a plurality of scanning beams emanating independent light sources, respectively, since the light source mount holds all of a plurality of light sources, there occurs no shift in relative position of the light sources. As a result, the color image forming machine forms a color image on a recording medium without producing distortion and unclearness of the image.

The light sources and all necessary optical elements are mounted on the light source mount as one whole unit and optically adjusted suitably for scanning. The light source unit can be simply and easily installed to the housing of the optical scanning device. This enables simply assembling an image forming machine with an effect of lowering costs of the image forming machine. Moreover, the housing of the optical scanning device made of a plastic member is contributory to lowering costs of the optical scanning device. This enables employing a metal light source mount, which is generally expensive as compared with a plastic light source mount, without increasing substantial costs of the optical scanning device.

It is to be understood that although the present invention has been described in detail with respect to the preferred embodiments thereof, various other embodiments and variants may occur to those skilled in the art, which are within the scope and spirit of the invention, and such other embodiments and variants are intended to be covered by the following claims.

What is claimed is:

1. A light source unit comprising at leas a light source for an optical scanning device having a housing and an scanning optical system which includes at least deflection means arranged in the housing for deflecting a scanning beam emanating from the light source and impinging thereon so as to direct the scanning beam toward an image carrier which is scanned by the scanning beam, said light source unit comprising:
a light source mount configured so as to fixedly hold the light sources, said light source mount being made of a member which has a coefficient of thermal liner expansion in a specified permissible range; and
positioning means for positioning said light source mount in a specified position relative to the housing and detachably fixing said light source mount to the housing.

2. A light source unit as defined in claim 1, comprising a plurality of light sources all of which are held by said light source mount so as to emit scanning beams parallel with one another, respectively.

3. A light source unit as defined in claim 1, and further comprising a collimator lens and a cylindrical lens provided for said light source, said collimator lens and said cylindrical lens being operative to collimate and focus said scanning beam on said image carrier.

4. A light source unit as defined in claim 2, and further comprising a collimator lens and a cylindrical lens provided for each said light source, said collimator lens and said cylindrical lens being operative to collimate and focus said scanning beam on said image carrier.

5. A light source unit as defined in claim 1, and further comprising a collimator lens and a cylindrical lens operative to collimate and focus said scanning beam on said image carrier, and scanning beam path adjusting means for displacing an optical path of said scanning beam coming out of said scanning beam path adjusting means from and parallel with an original optical path of said scanning beam.

6. A light source unit as defined in claim 3, and further comprising scanning beam path adjusting means for displacing an optical path of said scanning beam coming out of said scanning beam path adjusting means from and parallel with an original optical path of said scanning beam.

7. A light source unit as defined in claim 4, and further comprising scanning beam path adjusting means for displacing an optical path of said scanning beam coming out of said scanning beam path adjusting means from and parallel with an original optical path of said scanning beam.

8. A light source unit as defined in claim 1, wherein said light source unit is installed to said housing of the optical scanning device made of a plastic member.

9. A light source unit comprising at leas a light source for an optical scanning device having a housing and an scanning optical system which includes at least deflection means arranged in the housing for deflecting a scanning beam emanating from the light source and impinging thereon so as to direct the scanning beam toward an image carrier which is scanned by the scanning beam, said light source unit comprising:
a light source mount configured so as to fixedly hold the light sources, said light source mount being made of a member which causes a deformation within a specified permissible extent due to at least either one of a change in ambient temperature and external force; and
positioning means for positioning said light source mount in a specified position relative to the housing and detachably fixing said light source mount to the housing.

10. A light source unit as defined in claim 9, comprising a plurality of light sources all of which are held by said light source mount so as to emit scanning beams parallel with one another, respectively.

11. A light source unit as defined in claim 9, and further comprising a collimator lens and a cylindrical lens provided for said light source, said collimator lens and said cylindrical lens being operative to collimate and focus said scanning beam on said image carrier.

12. A light source unit as defined in claim 10, and further comprising a collimator lens and a cylindrical lens provided for each said light source, said collimator lens and said cylindrical lens being operative to collimate and focus said scanning beam on said image carrier.

13. A light source unit as defined in claim 9, and further comprising a collimator lens and a cylindrical lens operative to collimate and focus said scanning beam on said image carrier, and scanning beam path adjusting means for displacing an optical path of said scanning beam coming out of said scanning beam path adjusting means from and parallel with an original optical path of said scanning beam.

14. A light source unit as defined in claim 11, and further comprising scanning beam path adjusting means for displacing an optical path of said scanning beam coming out of said scanning beam path adjusting means from and parallel with an original optical path of said scanning beam.

15. A light source unit as defined in claim 12, and further comprising scanning beam path adjusting means for displacing an optical path of at least one of said scanning beams out of said scanning beam path adjusting means from and parallel with an original optical path of said scanning beam.

16. A light source unit as defined in claim 9, wherein said light source unit is installed to said optical scanning device made of a plastic member.
